(19) United States
(12) Patent Application Publication
(10) Pub. No.: US 2003/0124052 A1
(43) Pub. Date: Jul. 3, 2003

(54) Production of alkaline earth metal ferrites

(76) Inventors: Lloyd Ballard Mauldin, Cartersville, GA (US); Jerry Allen Cook, Cartersville, GA (US)

Correspondence Address: CHEMICAL PRODUCTS CORPORATION, P.O. BOX 2470, 102 OLD MILL ROAD S.E., CARTERSVILLE, GA, 30120-1692, US

(21) Appl. No.: 10/035,382

(22) Filed: Dec. 28, 2001

(51) Int. Cl. C01G 49/02

(52) U.S. Cl. 423/594.2

(57) ABSTRACT

A method is disclosed for the manufacture of barium or strontium ferrite from a chloride solution containing barium or strontium ions and ferrous ions by a pyrohydrolysis reaction catalyzed by carbon dioxide. The presence of carbon dioxide in the heated atmosphere in which pyrohydrolysis of an admixture of alkaline earth metal chloride and iron chloride is carried out substantially decreases the temperature required for reaction to occur.

### BACKGROUND OF THE INVENTION

1. Field of the Invention

This invention relates to the production of magnetic powders composed of barium or strontium ferrite to be employed as raw materials in the production of polymer-bound magnets and ceramic permanent magnets.

2. Description of the Related Art

Barium and strontium hexaferrite powders, represented by the formula MO·(Fe₂O₃)ₓ where M is barium or strontium and x is about 5 to 6, are crystalline compounds produced for incorporation into a polymeric matrix to form flexible magnetic materials or into ceramic permanent magnets.

The most prevalent current production method for barium or strontium hexaferrite powder is the preparation of an admixture of discrete particles of barium carbonate or strontium carbonate and discrete particles of ferric oxide, then reaction of the admixture at high temperature for a period of several hours. The barium or strontium carbonate and iron oxide may be admixed as dry powders, or they may be formed into an aqueous suspension and mixed prior to introduction into a heating device. In some cases, an aqueous suspension of barium or strontium carbonate and iron oxide is subjected to ball milling or some other grinding process to reduce the size of the individual particles prior to introduction into a heating device. The reaction between the alkaline earth metal carbonate particles and iron oxide particles proceeds at temperatures above about 900° C. and is believed to proceed stepwise with the formation of intermediate ferrite products prior to the formation of the final crystalline barium or strontium hexaferrite displaying the desired magnetic properties. This production method suffers from problems associated with (1) difficulty in achieving a uniform admixture of the discrete particles of the reactants, (2) long reaction times resulting from the slow diffusion of the reactants from the discreet solid particles, and (3) difficulty in assuring that the alkaline earth metal carbonate particles and the iron oxide particles are of a consistent, small size so as to yield a consistent number of surface contact sites which can become ferrite crystal nucleation sites under high-temperature reaction conditions.

Several techniques have been invented to try to overcome the shortcomings of the admixed discrete powder method for producing barium and strontium hexaferrites. U.S. Pat. No. 4,116,752 teaches preparation of strontium hexaferrite or barium hexaferrite particles by reacting iron oxide, iron hydroxide, or iron oxyhydroxide with strontium or barium carbonate, carboxylate, oxide, or hydroxide in the presence of strontium chloride or barium chloride flux. After reacting this admixture at temperatures up to 1300° C., the water-soluble barium chloride or strontium chloride flux is extracted from the ferrite product by washing with water. This procedure is taught to produce well-defined single crystals that are not agglomerated.

U.S. Pat. No. 4,062,922 teaches that strontium nitrate solution and ferric nitrate solution can be admixed to prepare a solution containing 10.8 molecular weights of iron for each molecular weight of strontium, and this admixture can be dried in a spray dryer. The dried material from the spray dryer is then heated in air at 600° C. for about 16 hours to obtain intimately mixed grains of iron oxide and strontium oxide less than 0.02 microns in diameter; further heating at 1000° C. for 4 hours yields ferrite powder of composition SrFe_{10.8}O_{17.2}, or SrO.5.4Fe₂O₃.

U.S. Pat. No. 4,062,922 teaches preparation of alkaline earth metal ferrite magnets beginning with nitrate solutions. U.S. Pat. No. 5,306,592, teaches coprecipitation of barium or strontium hydroxide and iron hydroxide to form a raw material for ferrite production. These patents teach that particles composed of co-precipitated alkaline earth metal salt and iron salt can be subjected to high temperature reaction conditions to yield alkaline earth ferrite powders with superior magnetic properties if the salts can be easily decomposed to the oxides by heating. U.S. Pat. No. 4,025,449 teaches that mixed hydroxide precipitates containing alkaline earth metal ions and ferric iron ions in the proportions necessary to produce alkaline earth metal hexaferrite can be recovered from solutions of soluble iron salts and soluble alkaline earth metal salts; insoluble hydroxide precipitates are formed when a solution of an alkaline earth metal salt and a solution of a ferric iron salt are admixed and then added to an alkali metal hydroxide solution. This precipitate can then be reacted at temperatures up to 1500° C., for times up to several hours, to yield consistent fine crystals of alkaline earth metal hexaferrite. Thus, it is well established that intimate admixtures of barium or strontium compounds and ferric iron compounds can be advantageously employed to produce barium or strontium hexaferrite crystals with superior magnetic properties; however, the prior art methods for achieving intimate admixture have suffered from various serious drawbacks including relatively expensive raw materials, the handling of aqueous suspensions of gelatinous precipitates, disposal or treatment of dilute salt solutions, and possibly the control of air emisssions of pollutants such as oxides of nitrogen.

Almost all of the iron oxide presently being used as a raw material in the production of alkaline earth metal hexaferrite powders is a by-product of the recovery of hydrochloric acid from spent steel pickle liquor. The surface of steel sheet is cleaned by contacting it with a hydrochloric acid solution which dissolves the scale and corrosion present on the steel surface; this yields a ferrous chloride solution called spent pickle liquor. The most widely practiced means of dealing with this spent pickle liquor has become pyrohydrolysis in a spray roaster or similar equipment at temperatures up to about 1000° C. to yield hydrochloric acid (hydrogen chloride gas generated during the reaction absorbed in water) for reuse in the steel cleaning operation, and a ferric iron oxide powder by-product. This pyrohydrolysis reaction takes place in the presence of water vapor and oxygen as described by the following equation:

2FeCl₂+2H₂O+½O₂→Fe₂O₃+4HCl

Methods have been developed to produce ferric iron oxide derived from the spent pickle liquor that is acceptable for use in the ferrite magnet industry, as a pigment, and in other applications.

Since the iron oxide utilized as a raw material in the production of alkaline earth metal ferrite magnets is recovered from iron chloride solution by a pyrohydrolysis reaction, direct production of particles composed of an intimate admixture of strontium or barium ferrite and ferric iron oxide by pyrohydrolysis eliminates duplication of processing steps and overcomes many of the shortcomings of the admixed discrete powders method of producing alkaline earth metal ferrite magnetic powders.

U.S. patent application Ser. No. 09/643,894 assigned to Chemical Products Corporation, teaches that particles composed of intimately admixed alkaline earth metal ferrite and ferric oxide can be produced from a solution containing alkaline earth metal chloride and iron chloride. This chloride solution reacts to form alkaline earth metal ferrite and ferric oxide at temperatures above about 800° C., and preferably above about 1000° C., in an atmosphere containing oxygen and water vapor. Spray roasting a chloride solution containing alkaline earth metal ions and iron ions in a ratio of about 1 alkaline earth metal atom to about 11.5 iron atoms yields an intimate admixture of alkaline earth metal ferrite and iron oxide that can be advantageously employed in the production of alkaline earth metal hexaferrite magnetic powders by subjecting the admixture to further heating to a temperature above about 900° C.

Published European Patent Application number 1 090 884, to Sumitomo Special Metals Co., Ltd., teaches admixing a hydrocarbon fuel with a chloride solution containing alkaline earth metal ions and iron ions to be sprayed into the spray roaster. This additional fuel input increases the temperature in the reaction zone above that achieved by supplying heat only by heating the gases entering the spray roaster. The application teaches that in this way the temperature in the reaction zone of a spray roaster can be increased sufficiently to form crystalline strontium or barium hexaferrite from a solution of barium or strontium chloride and iron chloride sprayed into the spray roaster.

The production of alkaline earth metal hexaferrite powder from a solution of chlorides by the prior art methods, while an improvement over previous methods, still suffers from the drawback that high temperatures are required to achieve reaction of the alkaline earth metal chloride with water and iron oxide to yield an alkaline earth metal ferrite.

### BRIEF SUMMARY OF THE INVENTION

We have found that a chloride solution containing alkaline earth metal ions and iron ions will react with oxygen and water vapor to yield hydrogen chloride, ferrric oxide, and alkaline earth metal ferrite at a significantly lower temperature if carbon dioxide is also present in the heated atmosphere. Pyrohydrolysis is the term used to describe the reaction of oxygen and water vapor with ferrous chloride to yield ferric oxide and hydrogen chloride, and the reaction of water vapor with strontium chloride. A chloride solution containing alkaline earth metal ions and iron ions can be sprayed into a heated atmosphere containing oxygen, water vapor, and carbon dioxide, to undergo pyrohydrolysis to form an intimate admixture of alkaline earth metal ferrite and iron oxide at a substantially lower temperature than the temperature required to carry out this reaction in an atmosphere containing the same concentration of oxygen and water vapor, but containing nitrogen rather than carbon dioxide. The catalytic effect of carbon dioxide upon the reaction is unexpected and not well understood.

It is an object of the present invention to reduce the cost of producing alkaline earth metal ferrites directly from ferrous chloride solution resulting from the cleaning of steel with hydrochloric acid by utilizing a gaseous catalyst to reduce the temperature necessary to convert an intimate admixture of alkaline earth metal chloride and iron chloride to alkaline earth metal ferrite. It is a further object of the present invention to produce alkaline earth metal ferrite utilizing the type of spray roaster pyrohydrolysis process equipment currently being used to produce hydrogen chloride and ferric oxide from spent pickle liquor ferrous chloride solution. It is yet a further object of the present invention to produce crystalline alkaline earth metal hexaferrites having a substantially uniform small particle size by catalytically promoting the pyrohydrolysis of a chloride solution containing alkaline earth metal ions and iron ions to allow nucleation and growth of alkaline earth metal hexaferrite crystals to more readily proceed thereafter.

### DETAILED DESCRIPTION OF THE INVENTION

The present invention concerns a process for preparing particles composed of a multitude of barium or strontium ferrite crystals from a chloride solution containing strontium or barium ions and iron ions. It has been discovered that carbon dioxide promotes the reaction of an admixture of alkaline earth metal chloride and iron chloride with oxygen and water vapor at elevated temperatures. It is speculated that the carbon dioxide specifically catalyzes the reaction of the alkaline earth metal chloride with water vapor and ferric oxide to form alkaline earth metal monoferrite. The pyrohydrolysis of alkaline earth metal chloride is considered to occur at higher temperatures than the pyrohydrolysis of iron chloride.

The process of the present invention involves coprecipitation of alkaline earth metal chloride and iron chloride as an intimate admixture through evaporation of water from a chloride solution containing alkaline earth metal ions and iron ions. The coprecipitated chlorides are then reacted at temperatures from about 800° C. up to about 1300° C., and preferrably from about 1000° C. up to about 1100° C., with water vapor and oxygen in the presence of carbon dioxide. The carbon dioxide should be present at a level of at least about 5% by weight in the heated atmosphere in contact with the coprecitated chlorides, and preferrably carbon dioxide should make up at least about 20% by weight of the heated atmosphere. It is contemplated that this invention would be employed to directly produce barium or strontium hexaferrite powder. This can be accomplished in a spray roaster, and other similar types of equipment, through the formation of intermediate ferrites at lower temperatures as a result of the catalytic action of carbon dioxide. The formation of intermediate ferrites at lower temperatures will promote more rapid nucleation and growth of alkaline earth metal hexaferrite crystals as the reaction temperature is increased.

We hypothesize that when a chloride solution containing strontium or barium ions in addition to iron ions is subjected to pyrohydrolysis, the ferrous chloride reacts first in the presence of water vapor and oxygen as described by the following equation:

2FeCl₂+2H₂O+½O₂→Fe₂O₃+4HCl;

subsequently, at a higher temperature, the strontium chloride or barium chloride reacts with water vapor and the previously formed ferric oxide to yield strontium monoferrite, or barium monoferrite, and hydrogen chloride as shown in the following chemical equation for strontium:

SrCl₂+Fe₂O₃+H₂O→SrFe₂O₄+2HCl

SrFe₂O₄ is also written, SrO.Fe₂O₃

In both reactions a significant loss of weight of the solids undergoing reaction occurs as the heavier chloride becomes part of the gas phase and is replaced by oxygen in the solid phase.

If the proportion of strontium atoms to iron atoms in the chloride solution is within the range required for the eventual formation of strontium hexaferrite crystals (1:11.5), the theoretical weight loss for the conversion of only the ferrous chloride present in the 1:11.5 chloride solution to ferric oxide is 33.4%; whereas, the theoretical weight loss for conversion of both the strontium chloride and the ferrous chloride to strontium ferrite and ferric oxide is 36.8%. Thus, the reaction of the strontium chloride increases the weight loss to about 110% of the weight loss expected from the reaction of the ferrous chloride alone. This weight loss from the solid phase can be observed and measured to evaluate the degree of completion of the pyrohydrolysis reaction; significantly increased weight loss upon heating to 800° C. has been observed as the amount of carbon dioxide in the atmosphere in contact with the solid chloride reactants has increased.

The process of the present invention can be practiced by spraying a chloride solution containing alkaline earth metal ions and iron ions into a heated atmosphere containing at least about 5 weight percent carbon dioxide, and preferable at least about 20 weight percent carbon dioxide. In a particular application of the present invention, chloride solution containing alkaline earth metal ions and iron ions may be heated to a temperature up to about 800° C. in an atmosphere containing sufficient oxygen and water vapor to effect reaction of ferrous chloride with oxygen and water vapor to form ferric oxide, then the powder so formed may be subsequently exposed to a heated atmosphere at a temperature of up to about 1300° C., and preferrably between about 1000° C. and about 1100° C., containing low levels of oxygen, water vapor, and at least about 5 weight percent carbon dioxide to effect pyrohydrolysis of the alkaline earth metal chloride and to form alkaline earth metal hexaferrite crystals.

While the invention has been described with particular reference to a preferred embodiment, it will be understood by those skilled in the art that various changes may be made and equivalents may be substituted for elements of the preferred embodiment without departing from the invention. In addition, many modifications may be made to adapt a particular situation and material to a teaching of the invention without departing from the essential teachings of the present invention

Additional objectives and advantages of this invention can be deduced from the following examples, or may be learned by practice of the invention.

### EXAMPLE 1

Reagent grade hydrated ferrous chloride, FeCl₂.4H₂O, and reagent grade hydrated strontium chloride, SrCl₂.6H₂O were weighed into a beaker in the proper proportion to yield a ratio of one strontium atom to 11.5 iron atoms. Distilled water was added to the beaker to dissolve the chlorides, and the beaker was stirred and heated to drive off water until the chlorides formed a solid mass at the bottom of the beaker. This solid mass was crushed and ground in a mortar and pestle to form a fine powder of intimately admixed strontium chloride and ferrous chloride.

The intimately admixed strontium chloride and ferrous chloride powder was subjected to thermal gravimetric analysis in three different gas atmospheres; in each case a sample weighing about 2 grams was heated at the rate of 10° C. per minute to a temperature above 800° C. The three gas atmospheres tested were

Atm. 1-20% Water, 18% Oxygen, balance Nitrogen

Atm. 2-20% Carbon Dioxide, 20% Water, 18% Oxygen, balance Nitrogen

Atm. 3-40% Carbon Dioxide, 20% Water, 18% Oxygen, balance Nitrogen

The carbon dioxide, oxygen, and nitrogen were weighed into a pressurized cylinder, then the gas in the cylinder was bubbled through heated water to achieve 20 weight percent water vapor in the mixture of gases introduced into the furnace containing the sample undergoing thermal gravimetric analysis.

In all three tests, weight was lost almost from the onset of heating; this is assumed to be exclusively loss of water of hydration below a temperature of about 300° C. In each test, 34% of the sample weight was lost in heating to 300° C. Weight loss at temperatures above about 300° C. is assumed to be the result of some further loss of water of hydration, as well as weight loss resulting from the following reactions

2FeCl₂+2H₂O+½O₂→Fe₂O₃+4HCl, in which 253.6 grams of solid ferrous chloride is converted into 159.7 grams of solid ferric oxide (all other reactants and products are gases); and, subsequently,

SrCl₂+H₂O+Fe₂O₃→SrFe₂O₄+2HCl, in which 318.3 grams of solid reactants are converted into 263.3 grams of solid products (with the other reactants and products being gases).

It is assumed that the reaction of strontium chloride occurs after essentially all of the iron chloride has been converted to ferric oxide. The theoretical weight loss for the conversion of only the anhydrous ferrous chloride present in the tested admixture to ferric oxide is 33.4%; whereas, the theoretical weight loss for conversion of the entire anhydrous admixture of strontium chloride and ferrous chloride to strontium ferrite and ferric oxide is 36.8%.

Table 1 below shows the observed weight loss when three samples of the same test material were heated in different atmospheres:

| | Atm. 1 - | Atm. 2 - | Atm. 3 - |
|---|---|---|---|
| | 0% CO2 | 20% CO2 | 40% CO2 |
| Weight loss | 34% | 34% | 34% |
| upon | | | |
| reaching | | | |
| 300° C. | | | |
| Cumulative | 64.8% | 69.0% | 70.4% |
| weight loss | | | |
| upon | | | |
| reaching | | | |
| 800° C. | | | |

### EXAMPLE 2

Strontium carbonate powder is reacted with hydrochloric acid solution to form a strontium chloride solution having a pH of about 4. The strontium chloride solution is mixed with an iron chloride solution in proportions such that the final chloride solution contains 50 g/L of strontium chloride and 440 g/L of ferrous chloride, that is, 11 molecular weights of iron for each 1 molecular weight of strontium. The solution is continuously sprayed into a spray-roasting reactor which consists of a cylindrical tower lined with refractory ceramic material and several burners arranged around the circumference of the lower portion of the cylinder. These burners burn hydrocarbon fuel with oxygen-enriched air to supply hot gases containing more than 30 weight percent carbon dioxide to the inside of the reactor, producing a rotary flow and subjecting the particles resulting from the drying of the spray droplets to temperatures in excess of 1000° C. A powder consisting of strontium ferrite is continuously withdrawn from the lower part of the reactor by means of a rotary valve. The gases from the reactor are cooled and hydrochloric acid gas is scrubbed out of the cooled gases, thus the hydrochloric acid required to form strontium chloride from the strontium carbonate is recovered and does not represent an expensive addition to the cost of the process.

The hot strontium ferrite powder is transferred to a rotary kiln as it leaves the spray roaster to be heated to a temperature in excess of about 1000° C. for a time sufficient to grow strontium hexaferrite of the desired size.

As is evident from the foregoing description, certain aspects of the invention are not limited to the particular details of the examples illustrated, and it is therefore contemplated that other modifications and applications will occur to those skilled in the art. It is accordingly intended that the claims shall cover all such modifications and applications as do not depart from the true spirit and scope of the invention.

We claim:

1. The method of producing particles composed of alkaline earth metal ferrite from a chloride solution containing alkaline earth metal ions and iron ions by spraying said chloride solution into a heated atmosphere containing at least about 5 weight percent carbon dioxide in addition to oxygen and water.

2. The method of claim 1, in which the chloride solution containing alkaline earth metal ions and iron ions contains strontium ions.

3. The method of claim 1, in which the chloride solution containing alkaline earth metal ions and iron ions contains barium ions.

4. The method of claim 1, in which the chloride solution containing alkaline earth metal ions and iron ions contains both barium ions and strontium ions.

5. The method of claim 1, in which the chloride solution containing alkaline earth metal ions and iron ions contains ferrous iron ions.

6. The method of claim 1, in which the chloride solution containing alkaline earth metal ions and iron ions is sprayed into a spray roaster.

7. The method of claim 1, in which the alkaline earth metal ferrite formed is alkaline earth metal hexaferrite.

8. The method of producing particles of alkaline earth metal ferrite from a chloride solution containing alkaline earth metal ions and iron ions, which comprises:
(a.) Heating the chloride solution to evaporate water from the solution and form a solid composed of coprecipitated alkaline earth metal chloride and iron chloride;
(b.) Heating the solid composed of coprecipitated alkaline earth metal chloride and iron chloride to a temperature from about 800° C. to about 1300° C. in an atmosphere containing more than about 5 weight percent carbon dioxide, in addition to water vapor and oxygen, to form hydrogen chloride gas and alkaline earth metal ferrite.

9. The method of claim 8, in which the chloride solution containing alkaline earth metal ions and iron ions contains ferrous iron ions.

10. The method of claim 8, in which the chloride solution containing alkaline earth metal ions and iron ions contains strontium ions.

11. The method of claim 8, in which step (a.) and step (b.) are carried out in a single piece of equipment.

12. Alkaline earth metal ferrites produced by the method of claim 8.

13. The method of claim 8, in which the atmosphere in step (b.) contains at least about 20 weight percent carbon dioxide.

14. The method of producing particles of alkaline earth metal ferrite from a chloride solution containing alkaline earth metal ions and iron ions, which comprises:
(a.) Heating the chloride solution to evaporate water from the solution and form particles composed of coprecipitated alkaline earth metal chloride and iron chloride;
(b.) Heating the particles composed of coprecipitated alkaline earth metal chloride and iron chloride to a temperature from about 400° C. to about 800° C. in contact with water vapor and oxygen to form hydrogen chloride gas and particles composed of ferric oxide intimately admixed with alkaline earth metal chloride.
(c.) Heating the particles composed of ferric oxide intimately admixed with alkaline earth metal chloride to a temperature from about 800° C. to about 1300° C. in an atmosphere containing more than about 5 weight percent carbon dioxide, as well as water vapor, to form hydrogen chloride gas and particles of alkaline earth metal ferrite.

15. The method of claim 14, in which the chloride solution containing alkaline earth metal ions and iron ions contains ferrous iron ions.

16. The method of claim 14, in which the chloride solution containing alkaline earth metal ions and iron ions contains strontium ions.

17. The method of claim 14, in which the atmosphere in step (c.) contains at least about 20 weight percent carbon dioxide.

18. Particles of alkaline earth metal ferrite produced by the method of claim 14.

19. The method of claim 14, in which the particles of alkaline earth metal ferrite produced in step (c.) are particles of alkaline earth metal hexaferrite.

20. The method of claim 14, in which steps (a.) and (b.) are carried out in a spray roaster.
